(19) United States
(12) Patent Application Publication
(10) Pub. No.: US 2026/0249265 A1
(43) Pub. Date: Aug. 27, 2026

(54) RECIRCULATORY FIBER REACTOR

(71) Applicant: CHEMTOR, LP, Lockhart, TX (US)

(72) Inventors: J. Jordan Clements, Lockhart, TX (US); Peter A. Eckert, Lockhart, TX (US); William Lanier, Lake Placid, FL (US)

(21) Appl. No.: 19/061,563

(22) Filed: Feb. 24, 2025

(51) Int. Cl. B01J 19/24; B01J 19/30; C01B 7/14

(52) U.S. Cl. CPC B01J 19/2435; B01J 19/30; C01B 7/14; B01J 2219/00018; B01J 2219/1945; B01J 2219/30257

(57) ABSTRACT

A recirculatory fiber reactor includes a conduit having a hollow interior, a plurality of fibers disposed within the hollow interior of the conduit, an inlet in fluid communication with the hollow interior of the conduit, and an outlet in fluid communication with the hollow interior of the conduit. The conduit is nonlinear and forms a closed loop to recirculate reactants through the conduit and along the fibers.

### TECHNICAL FIELD OF THE DISCLOSURE

The present disclosure generally relates to a conduit contactor for facilitating chemical reactions and/or chemical extractions. More particularly, the disclosure relates to a conduit contactor including a plurality of fibers disposed therein and configured to continually recirculate fluid reactants therethrough.

### BACKGROUND OF THE DISCLOSURE

Fiber reactors are a class of chemical reactors which have generally been used to mix multiple immiscible streams of feedstock. A typical fiber reactor, such as that shown in FIG. 1, is comprised of a tubular body or reactor shell 3 in which a number of fibers 4 are laid parallel to the length of the reactor shell 3. The sizes, material composition, and quantity of the fibers 4 contained within the reactor shell 3 vary with the intended application, but the length of the fibers 4 is typically the same as, or slightly longer than, the length of the reactor shell 3. One or more streams of feedstock are introduced to the interior of the reactor shell 3 and the bundle of fibers 4 within at one end of the reactor shell via inlets 1 and/or 2, and the feed streams are passed through the reactor along the bundle of fibers 4 and collected in a receiving vessel at the other end 5 of the reactor shell. FIG. 1 depicts a vertical fiber reactor (oriented parallel to the force of gravity) with flow in the direction of arrow 6.

Fiber reactors have been used extensively in processes which benefit from the non-dispersive mixing of two or more immiscible fluids. When two immiscible fluids are passed simultaneously through a fiber-packed reactor the two fluids are typically intimately contacted while passing through the void space between the fibers. This contact provides many of the physical and chemical effects of classic dispersive mixing processes without facilitating emulsification. Fiber reactors have been used in several applications, including the refining of crude petroleum feedstocks and washing of edible oils, and have been demonstrated to show efficacy for various organic reactions and the solvent extraction of metals.

All chemical processes occur on a measurable timescale, and in order to allow a chemical process to reach completion it must be provided with the necessary time. Thus, fiber reactors must be designed such that fluids passing through the reactor shell are contained within the reactor long enough for the desired chemical process to reach completion. This timescale is referred to herein as “residence time,” and is defined by Equation 1:

$${τ}_{r} = v / f \qquad Equation 1$$

where τᵣ is the residence time of a reactor, ν is the total volume of the fiber-packed reactor shell, andf is the total flow rate into the reactor shell. For example, if the total volume of a packed fiber reactor was 1 m³, and 0.5 m³/second were passed through the packed reactor, the residence time of that reactor would be two seconds. Equation 1 demonstrates the intrinsic coupling between the volume, total flow rate, and residence time of a classic fiber reactor.

The interaction between two or more immiscible fluids within a fiber reactor may be modulated by the total flow rate of the two or more fluids. When the total flow rate through the fiber reactor is relatively low, fluid flow within the reactor is expected to be laminar, while high flow rates within the reactor are expected to be more turbulent. The optimal regime of fluid turbulence within a fiber reactor depends almost exclusively on the chemical and physical properties of the process—some processes benefit more from laminar conditions than from turbulent conditions, and vice versa.

Equation 1 indicates that fiber reactors must be carefully designed for specific processes as constrained by the desired flow rate within the reactor and the desired residence time. When moderate or long residence times and high flow rates are simultaneously desired, fiber reactors may require packed volumes with a prohibitively high footprint, and exceptionally large or long reactor shells may cause separate logistical concerns. These concerns arise from the size required for a reactor in which the introduced fluid flows through the reactor, from one end to the other, at the desired flow rate.

### BRIEF DESCRIPTION OF THE DRAWINGS

The following figures illustrate embodiments of the subject matter disclosed herein. The claimed subject matter may be understood by reference to the following description taken in conjunction with the accompanying figures, in which:

FIG. 1 is a diagrammatic illustration of a prior art linear fiber reactor.

FIG. 2 is a diagrammatic illustration of a recirculatory fiber reactor according to an embodiment of the present disclosure.

FIG. 3 is a graph showing results from Example 2.

FIG. 4 is a graph showing results from Example 2.

FIG. 5 is a graph showing results from Example 2.

FIG. 6 is a graph showing results from Example 3.

### DETAILED DESCRIPTION

The following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

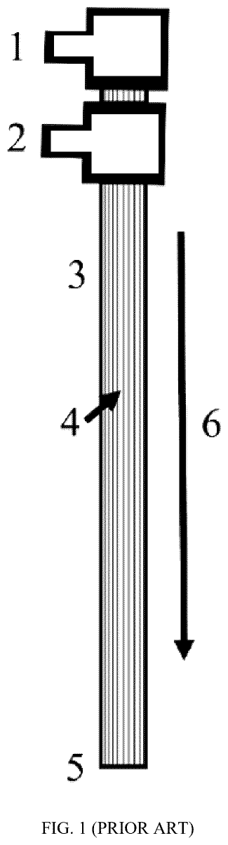

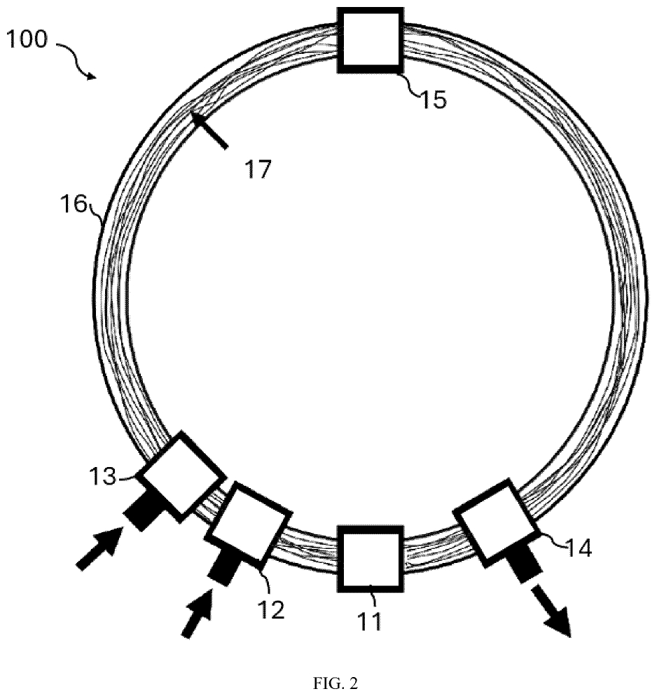

With reference to FIG. 1, a recirculatory reactor 100 is shown in which a reactor shell 16 is filled with fibers 17. In some embodiments, one or more phases of fluid feedstock (e.g., organic liquid, aqueous liquid, gas, or combinations thereof) may be introduced into an interior of the recirculatory reactor 100 and then passed through the reactor shell 16. Streams of fluid may be introduced into the reactor shell 16 through one or more direct inlets 12, 13—these inlets 12, 13 may be positioned anywhere along the length of the reactor shell 16, and fluid may be removed from the reactor shell through the outlet valve 14. The fluid may be continually recirculated within the body of the recirculatory reactor 100 through, e.g., the action of one or more inline pump 11. The inline pumps 11 may be built into the reactor shell 16 anywhere along the length of the reactor shell 16. Additionally, the fluid may be displaced from the interior of the reactor by the introduction of new feedstock and discharged via outlet valve 14. That is, fluid within the body of the reactor (i.e., within the reactor shell 16) may be moved within the reactor by the action of the inline pumps 11, and when the reactor shell is full of fluid and the outlet valve 14 is set to allow the passage of fluid, any volume added to the reactor shell 16 through the inlets 12, 13 will displace an equal amount through the outlet valve 14. In some embodiments, the recirculatory reactor 100 may include one or more degassing valves 15. This configuration allows continuous operation and completely decouples the flow rate of the fluid within the reactor shell 16 from the average residence time of a particle within the reactor shell 16.

The decoupling of residence time and flow rate manifests an additional benefit of allowing a stochastically retained reactant to traverse a greater distance of fiber length because of multiple revolutions through the system. In instances where the fibers have been functionalized with an enzyme or other catalytic moiety, the decoupling of flow rate and retention time functions to allow the reactants to traverse greater distances of the functionalized surface thus increasing the overall probability that the reactants and stationary catalysts present themselves in the appropriate stoichiometry and configuration. Examples of catalytic fiber reactors are described in WO 2024/151924, the entirety of which is hereby incorporated by reference.

In some embodiments, during construction or assembly of the recirculatory reactor 100, the reactor shell 16 may include two open ends that are joined to form a closed loop. In such embodiments, prior to joining the open ends, the reactor shell 16 may be packed with the fibers 17. The junction between the two open ends of the reactor shell 16 may be a direct connection or may include, e.g., a pump (such as inline pump 11) or a mixed or unmixed reservoir between the open ends (i.e., the open ends may be indirectly joined). In some embodiments, the junction between the two open ends of the reactor shell 16 may include a manifold and the manifold may include, e.g., one or more of the inlets 12, 13, or the outlet valve 14. That is, in some embodiments, any of the components of the recirculatory reactor 100 may be included between the ends of the reactor shell 16.

In some embodiments, the reactor shell 16 is packed with fibers 17 in the same manner as would be typical for a fiber reactor, but both ends of the reactor shell are then directly affixed to each other. The reactor shell 16 may be made from a wide range of materials including, but not limited to, metals, alloys, plastics or other polymers, fabrics, wood, or combinations thereof. When the reactor shell 16 is made of material that is sufficiently flexible, the shell may be directly bent to allow the affixing of the two ends. When the reactor shell 16 is made from a solid and inflexible material, like a metal alloy or wood, the reactor shell 16 may be formed in variety of ways. For example, the reactor shell 16 may be formed of one or more curved segments which are brought together to complete the recirculatory reactor 100, e.g., be four 90° curved metal elbow joints, which may be connected and packed with fibers along the length of the shell to form a configuration in which the reactor shell is effectively circular. As another example, the reactor shell 16 may be constructed in the form of an octagon from eight sections of PVC piping, each connected to the next at a 135° angle. In some embodiments, the solid or inflexible material may be deformed (e.g., by mechanical force, optionally, utilizing heat) after the fibers 17 are packed inside the reactor shell 16.

In some embodiments, the reactor shell 16 is composed of two or more differing materials, continuously or in discrete segments. In some embodiments, the reactor shell 16 is composed of discrete segments connected either physically or through the path of the feedstock. These discrete segments may be composed identical or differing physical materials, and may contain the same or differing bundles. In some embodiments, the reactor shell 16 includes physical discontinuities which include but are not limited to reservoirs with or without included fibers. In some such embodiments, there are one or more discontinuities in the fiber bundle or in which more than one discrete, overlapping, or minimally spaced bundles are incorporated into the body of the recirculatory reactor 100.

The exact shape of the reactor shell 16 is not particularly limited. The shape may include curved portions, angled portions, or combinations thereof. In some embodiments, the reactor shell 16 contains no discrete angles, being comprised of a shape that includes but is not limited to the elements of a circle, oval, helix, or wavy form. In some embodiments, the reactor shell 16 contains one or more discrete angles, being comprised of a shape that includes but is not limited to the elements of a regular polygon like a triangle, square, pentagon, hexagon, heptagon, octagon, nonagon, decagon, undecagon, dodecagon, or any higher polygon, or any combination of continuous curves and discrete angles. In some embodiments, the shape may also include straight portions disposed between the curved and/or angled portions.

In some embodiments, the shape may be in a single plane, e.g., a circle, an ovoid, a regular or irregular polygon, a regular or irregular polygon with rounded vertices, etc. In other embodiments, the shape may be three-dimensional, e.g., a corkscrew with ends thereof joined or a figure-8. A cross-section of the reactor shell 16 (i.e., perpendicular to direction of fibers 17 and direction of fluid flow) is not particularly limited and may be, e.g., circular or ovoid. In any embodiment, the shape of the reactor shell 16 may be nonlinear (i.e., at least of portion thereof being nonlinear) to facilitate recirculation from the second end back to the first end or vice versa.

One or more inlets 12, 13 are set anywhere along the length of the reactor shell 16 to allow the introduction of feedstock into the reactor shell, 16 and one or more outlet valves 14 are similarly set anywhere along the length of the reactor shell 16. One or more inline pumps 11 are incorporated into the reactor shell 16 anywhere along its length in whatever positions are determined optimal for the intended process, and one or more degassing valves 15 may be added anywhere along the length of the reactor shell 16 according to the desired process. The reactor shell 16 may also include other ports and inlets to accommodate additional instrumentation, to include but not be limited to pH meters, conductivity meters, pressure sensors, temperature sensors, or flow meters.

The reactor shell 16 is packed with fibers 17 according to the specifications set by the desired application. These fibers 17 may be composed of a wide range of materials, to include but not be limited to stainless steel, Hastelloy, and other metallic alloys, copper, iron, and other “pure” metals, plastics and other polymers, textiles, glasses, carbon-based tubules and nanomaterials, or combinations thereof. The size of the fibers 17 may be determined by the desired application, and could vary, e.g., from large polymeric fibers to microscopic textile fibers. The quantity of fibers 17 contained within the reactor shell 16 may be determined by a consideration of the intended process, and could vary, e.g., from as few as several fibers to as many as can be physically contained within the reactor shell 16. In some embodiments, the fibers 17 are sized such that they are long enough to extend through the entire reactor shell 16. In some embodiments, the fibers 17 may be shorter or longer than the length of the reactor shell 16. In some embodiments, two or more distinct bundles of fibers 17 may be contained within the body of a single recirculatory reactor 100. The ends of these bundles may be in direct physical contact, or be separated by void space or reservoirs. For example, the fibers 17 may include a first bundle and a second bundle and a total length of the bundles may be less than a length of the reactor shell 16 such that an upstream end of the first bundle is spaced from a downstream end of the second bundle and a downstream end of the first bundle is spaced from an upstream end of the second bundle. As another example, a total length of the bundles may be greater than a length of the reactor shell 16 such that an upstream end of the first bundle overlaps a downstream end of the second bundle and/or a downstream end of the first bundle overlaps an upstream end of the second bundle. When a plurality of bundles are used, the bundles may be the same or different from one another in terms of fiber composition, fiber diameter, fiber length, fiber number, etc.

In some embodiments, a method of operating the recirculatory reactor 100 includes introducing a reactant fluids separately or as a mixture into the reactor shell 16 and onto the fiber 17. The rate of input can be continuous and non-zero. Recirculation may naturally occur based on the stochastic nature of particle output and/or may be aided or enhanced by use of the inline pump 11. That is, even without the inline pump 11 operating, equal input and output flow rates within the recirculatory reactor 100 will still result in a portion of the liquid bypassing the outlet and recirculating through the reactor shell 16. In some embodiments, the rate of input can be stopped with the outlet closed and the inline pump 11 can be operated to recirculate the liquid for a desired amount of time before removing the liquid. In some embodiments, the operation can be continuous in that feedstock can be routinely introduced and removed from the recirculatory reactor 100 at routine or non-routine, non-zero intervals, wherein no feedstock or alternate matrix is introduced or removed between the routine or non-routine introductions. In some embodiments, the mixing regime may be achieved by precise control of the inline flow rate (e.g., controlling input flow rate and/or inline pump 11 rate). In some embodiments, the inline pump 11 can be modulated to create turbulence (e.g., increasing, decreasing, and/or reversing pump speed).

In linear fiber reactors, particles passed into the reactor shell follow a straight path through the reactor and pass out of the reactor shell in approximately the same order in which they were introduced into the reactor. The residence time of a particle within the reactor is inextricably linked to the flow rate of fluid through the fiber reactor shell. In contrast, particles passed into the recirculatory reactor 100 are continually recirculated within the reactor shell 16 and are stochastically displaced from the body of the recirculatory reactor 100 by the addition of new feedstock. The residence time of a particle within the recirculatory reactor 100 is completely decoupled from the flow rate within the reactor shell.

### Example 1

To demonstrate the decoupling of residence time and flow rate, a recirculatory reactor was constructed in the form of a rectangle with smoothly rounded vertices and packed with stainless steel fibers. The fibers had a 50 micron diameter and filled 32% of the volume within the reactor shell, leaving a packed volume of 400 ml. The reactor was filled with aqueous media, and continuously operated. A dose of concentrated saline solution was injected directly into the inlet, and the conductivity of the outlet stream was monitored until it had returned to its original baseline. The residence time distribution of the system at the operational parameters employed may be extracted directly from the conductivity measurement and normalized according to Equation 2:

$$E ( t ) = \frac{c ( t )}{\int c ( t ) d t} \qquad Equation 2$$

where c(t) is the conductivity of the outlet stream as a function of experimental time. The first moment of the residence time distribution of the system may be calculated according to Equation 3:

$$τ r = \int E ( t ) * t d t \qquad Equation 3$$

where τr is the measured average residence time, E(t) is the measured residence time distribution normalized to its area, and t is the time value of each conductivity measurement. To assess the interaction of residence time and inline flow rate, input flow rates of 6.7, 11.5, and 40.1 ml/min, and inline flow rates of 50, 100, and 150 ml/min were used. Table 1 shows the first moments of the residence time distribution for each of the measured combinations of input and inline flow rate

TABLE 1
Average residence times (min) measured from a saline tracer
for various input flow rates and inline flow rates:

| | | Input flow rate (ml/min) | | |
|---|---|---|---|---|
| | | 6.7 | 11.5 | 40.1 |
| Inline flow rate | 50 | 67.1 | 36.9 | 11.3 |
| (ml/min) | 100 | 78.7 | 37.5 | 13.1 |
| | 150 | 74.1 | 37.7 | 12.3 |

The measured residence times of the recirculatory reactor show little variance with increasing inline flow rate and a significant dependence upon the input flow rate. That is, the residence times clearly differ by input flow rate, which determines the average residence time according to Equation 1, but do not significantly differ by inline flow rate. This trend evident in Table 1, where the first moments of the residence time distribution show a marked dependence upon the input flow rate and no significant dependence on the inline flow rate. These data confirm the decoupling of residence time and inline flow rate with the recirculatory fiber reactor configuration.

### Example 2

The recirculatory reactor set-up described in Example 1 was used for the recirculatory measurements, and a classic linear reactor with a reactor shell that matched the length and diameter of the recirculatory reactor was prepared and packed in a matching way. Aqueous media was passed through the linear reactor at flow rates of 200, 80, 40, 20, 13, and 6.7 mL/min, and feed input flow rates of 200, 80, 40, 20, 13, and 6.7 mL/min, corresponding to calculated residence times of 2, 5, 10, 20, 30, and 60 minute residence times according to Equation 1. A saline tracer was injected into the input feed at t=0 and the conductivity of the output stream was continuously monitored until the conductivity readings returned to the previous baseline. The same experimental process was used with the recirculatory fiber reactor, and the inline flow rate of the recirculatory fiber reactor was matched to the input flow rate. Matching the input and inline flow rate in a recirculatory reactor is the only way to reasonably compare recirculatory and linear reactors, because in linear reactors the flow through the reactor is necessarily identical to the flow within the reactor shell.

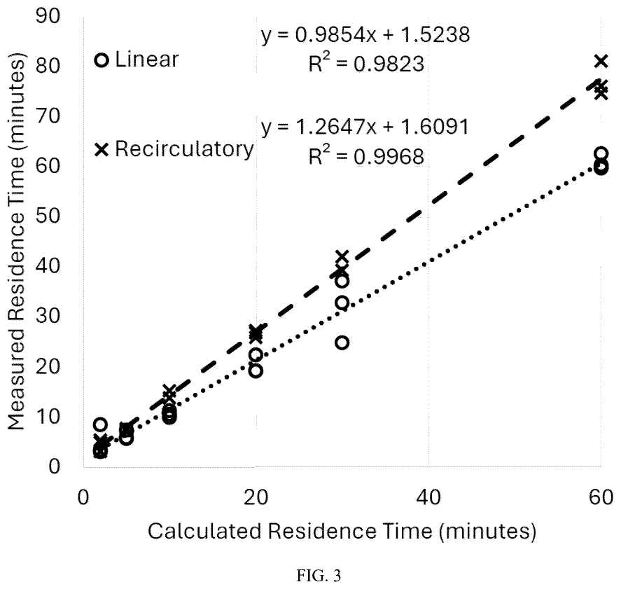

As shown in FIG. 3, the residence time of the recirculatory fiber reactor is ~25% greater than the residence time of a linear reactor with identical void volumes and input flow rates. The slopes of the best-fit linear regressions to the two data series are different at a 98% confidence interval.

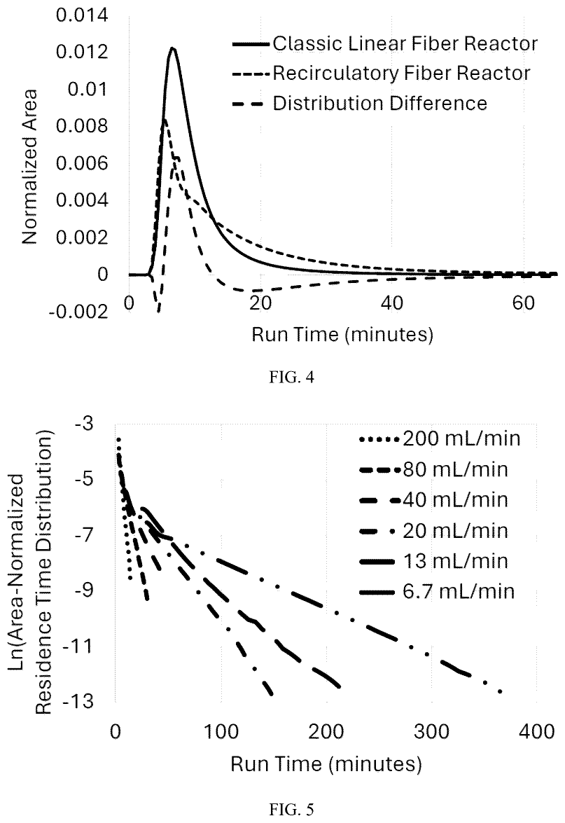

A comparison of the area-normalized residence time distributions for the input and inline flow rate of 40 mL/min is shown in FIG. 4 for the linear and recirculatory reactors. The residence time distribution of the recirculatory reactor is broader than the distribution for the linear reactor, which is expected in light of the stochastic nature of particle output from the recirculatory fiber reactor. The first moments of the residence time distributions for all of the flow rates were calculated according to Equation 3 and plotted against the expected residence times as calculated by Equation 1. A linear model was tested against the data series and the equation of best fit and the R² diagnostic are provided in the inset of FIG. 3 for both the linear and recirculatory fiber reactors.

A linear model shows excellent correspondence with the measured data for both the linear and recirculatory fiber reactors. The best-fit model for the classic linear reactor returns a slope of ~1, as expected: this indicates the adequacy of Equation 1 for predicting the residence times of linear fiber reactors. The best fit model for the recirculatory fiber reactors returns a slope of ~1.25, indicating that the average residence time of a particle in a recirculatory fiber reactor is ~25% longer than the average residence time of a particle in a corresponding linear fiber reactor and a lack of correspondence with the definition of average residence time provided by Equation 1.

The statistical similarity of the slopes of the best-fit models for classic linear and recirculatory fiber reactors was assessed through a Student's t-test. The t-test statistic for the two regression slopes was 2.52, indicating a rejection of the null hypothesis at a 98% confidence interval for the 31 pooled samples measured.

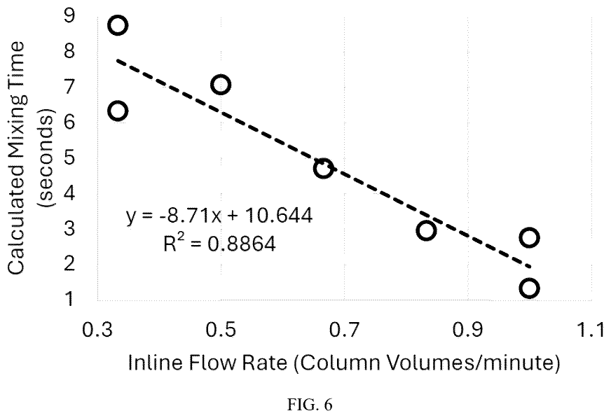

The failure of Equation 1 to predict the average residence time of a recirculatory fiber reactor is due to the fundamental difference in the physical design of linear and recirculatory fiber reactors. The operation of a classic fiber reactor is best conceptualized as the movement of discrete “packets” of fluid through the reactor shell to the reactor outlet. The operation of a recirculatory fiber reactor is best conceptualized differently—a “packet” of fluid is introduced to the body of the fiber reactor, but particles pass through the reactor outlet stochastically as the original “packet” of fluid is diluted by the introduction of additional feedstock. As such, the operation of a recirculatory fiber reactor is effectively a process of continuous dilution. The process of continuous dilution may be simplistically modeled according to Equation 4:

$$dc / dt = - k * c \qquad Equation 4$$

in which c represents the concentration of particles within the original “packet” of fluid, t represents the experimental time, and k is a constant determined by the operational parameters. The solution to Equation 4 is Equation 5

$$c ( t ) = m * {e}^{- k * t} \qquad Equation 5$$

in which c(t) is the concentration of the tracer particles at time t, m is a constant representing the concentration of particles within the reactor at time t=0, and k is the inverse of quantity known as the “lifetime” in kinetics which describes a characteristic timescale for the process. Equation 5 may be transformed into a linear function according to Equation 6:

$$ln ( c ( t ) ) = ln ( m ) - k * t \qquad Equation 6$$

in which the initial amplitude of the area-normalized residence time distribution may be extracted from the y-intercept of the linear regression and the lifetime of the exponential distribution is equal to the slope of the regression line. FIG. 5 shows the result of this transformation applied to the recirculatory data collected for this Example. The initial waiting time between injection of the saline tracer and the initial maximum of the residence time distribution is discarded, and the natural log of the remainder of the data set until the conductivity measurement approaches its baseline is taken. The resulting data series are all well fit by a linear model, providing confirmation for the hypothesis that the physical process of mixing in a recirculatory fiber reactor is well modeled by Equation 4.

### Example 3

Quantifying the efficacy of a mixing process is a challenging task on a microscopic level. Various approaches have been employed, including the use of dyes and specific chemical reactions with a known sensitivity to the degree of mixing on a microscopic scale. One such reaction is known as the Villermaux-Dushman reaction, and is composed of the competing equilibria detailed in Equation 7, Equation 8, and Equation 9:

$${H}_{2} B {0}_{3} - + H + ⇔ {H}_{3} {BO}_{3} \qquad Equation 7$$

$${IO}_{{3}^{-}} + 5 {I}^{-} + 6 {H}^{+} ⇔ 3 {I}_{2} + 3 {H}_{2} O \qquad Equation 8$$

$${I}_{2} + {I}^{-} ⇔ {I}_{3}^{-} \qquad Equation 9$$

Briefly, iodide and iodate are dissolved in a borate buffer and an acid is introduced to the system. The acid may react either with the borate buffer or with the iodate and iodide to form iodine. The reaction with the borate buffer system (Equation 7) is much faster than the redox reaction with iodate (Equation 8), so if the system is mixed vigorously enough to be homogenous on a microscopic level the acid will be absorbed by the buffer and no iodine will form. If the system is mixed weakly enough to allow the persistence of microscopic inhomogeneity there will be microscopic regions of the buffered medium in which the buffer capacity to absorb protons becomes saturated, in those regions the formation of iodine may occur. Iodine will spontaneously form an equilibrium with iodate (Equation 9), and the I₃⁻ anion absorbs strongly in the UV at ~353 nm, where its concentration may be directly measured with spectrophotometry.

The mixing time of the chemical reaction may be approximately with the empirically derived relationship described by Commenge et. al. in Equation 10:

$${t}_{m} = 0.33 * {{{{{( OD ) [ {H}^{+} ]}^{- 4.55} [ {I}^{-} ]}^{- 1.5} [ {IO}_{{3}^{-}} ]}^{5.8} [ NaOH ]}^{- 2} [ {H}_{3} {BO}_{3} ]}^{- 2} \qquad Equation 10$$

where tₘ is the calculated mixing time and OD is the measured optical density at 353 nm. In general, reaction media which are better mixed are expected to have a lower calculated mixing time.

A recirculatory fiber reactor was constructed out of PFA tubing with a ⅜″ inner diameter and a 48″ long reactor shell. The reactor was circularly shaped, oriented vertically, and a degassing valve was placed at the highest point in the reactor body. The reactor was packed to 32% of its volume with Hastelloy fibers which were 50 microns in diameter, giving the recirculatory reactor a packed volume of 60 ml. A stream of sodium iodate and sodium iodide in a borate buffer and a stream of aqueous sulfuric acid were introduced into the reactor through separate inlets, both at 10 mL/min (making a 3-minute residence time, as calculated by Equation 1) and the fluid within the reactor was recirculated at a range of inline flow rates. The reactor was allowed to equilibrate for 12 residence times (as defined in Equation 1) and the absorbance of the media leaving the reactor was measured at 352 nm. The mixing time of the reactor was calculated from the concentrations of the inlet streams and the measured optical density at the reactor outlet according to Equation 10. After each run the reactor was drained of fluid, washed with ethanol to remove any residual I₂, and washed with water purified by reverse osmosis to remove residual ethanol.

The calculated mixing times for the recirculatory reactor described above at a range of inline flow rates are shown in FIG. 6. The equation of best fit and the R² diagnostic are shown in the figure. The calculated mixing time decreases with an increasing inline flow rate, indicating that the mixing time of a recirculatory reactor may be controlled through modulation of the inline flow rate. FIG. 6 is not intended to provide a metric for mixing times for generic recirculatory fiber reactors: the mixing time of a recirculatory fiber reactor will vary with the pack density, fiber diameter, and other variables beside the inline flow rate, and different recirculatory fiber reactors will show different regimes of microscopic mixing.

FIG. 6 illustrates that in recirculatory fiber reactors the flow rate within the reactor and the residence time of feedstock within the reactor are completely decoupled. The input flow rate, and thus the residence time, of the recirculatory reactor was held constant throughout the experiment, but different mixing regimes were accessible through modulation of the inline flow rate. FIG. 6 also illustrates the design flexibility of a recirculatory fiber reactor as compared to a classic linear fiber reactor. Linear fiber reactors must be sized carefully to accommodate a specific residence time and inline flow rate, while recirculatory reactors may simply be sized for a residence time according to the feed rate specifications of the application, and the inline flow rate may be controlled to adjust the process without concern for a truncation or elongation of the process reaction time.

It is understood that variations may be made in the foregoing without departing from the scope of the present disclosure. In several example embodiments, the elements and teachings of the various illustrative example embodiments may be combined in whole or in part in some or all of the illustrative example embodiments. In addition, one or more of the elements and teachings of the various illustrative example embodiments may be omitted, at least in part, and/or combined, at least in part, with one or more of the other elements and teachings of the various illustrative embodiments.

What is claimed is:

1. A recirculatory fiber reactor comprising:
a conduit having a hollow interior;
a plurality of fibers disposed within the hollow interior of the conduit;
an inlet in fluid communication with the hollow interior of the conduit; and
an outlet in fluid communication with the hollow interior of the conduit;
wherein the conduit is nonlinear and forms a closed loop.

2. The recirculatory fiber reactor of claim 1, wherein the outlet comprises a valve.

3. The recirculatory fiber reactor of claim 2, further comprising an inline pump in fluid communication with the hollow interior of the conduit.

4. The recirculatory fiber reactor of claim 1, wherein the conduit extend from a first end to a second end; and
wherein the first end is in fluid communication with the second end.

5. The recirculatory fiber reactor of claim 4, wherein the first end is directly connected to the second end.

6. The recirculatory fiber reactor of claim 4, wherein the first end is indirectly connected to the second end via the inline pump.

7. The recirculatory fiber reactor of claim 4, wherein the first end is indirectly connected to the second end via a reservoir.

8. The recirculatory fiber reactor of claim 1, wherein the plurality of fibers comprises a first bundle of fibers and a second bundle of fibers; and
wherein an upstream end of the first bundle of fibers is suspended with the hollow interior of the conduit at a first position and an upstream end of the second bundle of fibers is suspended with the hollow interior of the conduit at a second position that is downstream of the first position.

9. A method of conducting chemical reactions or chemical extractions using the recirculatory fiber reactor of claim 1 comprising:
introducing a first liquid and a second liquid into the conduit and onto the plurality of fibers via the inlet;
recirculating at least a portion of the first liquid and at least a portion of the second liquid through the conduit;
forming reaction products by extracting at least one component from the first liquid into the second liquid or reacting at least one component from the first liquid with at least one component from the second liquid; and
removing at least a portion of the reaction products via the outlet.

10. The method according to claim 9, wherein removing at least a portion of the reaction products comprises introducing additional liquid via the inlet or the second inlet, wherein the additional liquid may be the same or different from the first liquid or the second liquid, and displacing the reaction products from the hollow interior of the conduit.

11. The method of claim 9, wherein recirculating comprises operating an inline pump in fluid communication with the hollow interior of the conduit and the method comprises controlling a flow rate of the inline pump to influence mixing of the first liquid and the second liquid.

12. A method of making a recirculatory fiber reactor comprising:
providing a hollow conduit extending from a first end to a second end;
suspending a plurality of fibers within the hollow conduit; and
fluidically coupling the first end of the hollow conduit to the second end of the hollow conduit;
wherein the hollow conduit is nonlinear after fluidically coupling the first end of the hollow conduit to the second end of the hollow conduit.

13. The method of claim 12, further comprising:
providing an inlet in fluid communication with the hollow conduit;
providing an outlet in fluid communication with the hollow conduit; and
providing an inline pump in fluid communication with the hollow conduit.

14. The method of claim 12, wherein the hollow conduit is formed of a flexible material and fluidically coupling the first end of the hollow conduit to the second end of the hollow conduit comprises bending the flexible material and directly or indirectly attaching the first end to the second end.

15. The method of claim 12, wherein providing the hollow conduit comprises providing a plurality of conduit segments, wherein at least one of the plurality of conduit segments is nonlinear.

16. The method of claim 15, further comprising joining the plurality of conduit segments prior to suspending the plurality of fibers within the hollow conduit.

17. The method of claim 15, further comprising joining the plurality of conduit segments concurrently with suspending the plurality of fibers within the hollow conduit.

18. The method of claim 12, wherein fluidically coupling the first end of the hollow conduit to the second end of the hollow conduit comprises coupling the first end of the hollow conduit to a first end of an inline pump and coupling the second end of the hollow conduit to a second end of the inline pump.

19. The method of claim 12, wherein fluidically coupling the first end of the hollow conduit to the second end of the hollow conduit comprises coupling the first end of the hollow conduit to a first end of a reservoir and coupling the second end of the hollow conduit to a second end of the reservoir.

20. The method of claim 12, wherein fluidically coupling the first end of the hollow conduit to the second end of the hollow conduit comprises coupling the first end of the hollow conduit to a first end of a manifold and coupling the second end of the hollow conduit to a second end of the manifold, wherein the manifold comprises at least one inlet and an outlet.
